(19) United States
(12) Patent Application Publication
(10) Pub. No.: US 2001/0005958 A1
(43) Pub. Date: Jul. 5, 2001

(54) Turf surfaces

(76) Inventor: Gabriel Casimaty, Seymour (AU)

Correspondence Address: LARSON & TAYLOR, PLC, 1199 NORTH FAIRFAX STREET, SUITE 900, ALEXANDRIA, VA, 22314, US

(21) Appl. No.: 09/749,882

(22) Filed: Dec. 29, 2000

(30) Foreign Application Priority Data
Dec. 31, 1999 (AU) PQ4931

(51) Int. Cl. A01C 1/00

(52) U.S. Cl. 47/1.01 F

(57) ABSTRACT

A composite membrane comprising a first layer of fine mesh secured at closely spaced intervals to a plastics sheet, the plastics sheet having an array of apertures, the area of the apertures being less to 15% of the area of the sheet.

### INTRODUCTION

This invention relates to improvements in or relating to turf surfaces and more particularly relates to a composite membrane that can be used in a turf product.

### DISCUSSION OF THE PRIOR ART

The designers of modern day stadia have to balance the demand of a high quality playing surface for a variety of sports with the need for a large arena with quality viewing for spectators; compensation for the variability of weather and often the flexibility for multipurpose use to ensure an adequate income. These parameters place heavy demands on stadia that incorporated grass. A number of sports can only be played on a real grass surface, however these sports demand a good quality playing surface, demand excellent viewability from a spectator point of view and often even include opportunities for closing the roof of the stadia to protect from inclement weather. Modern day stadia have huge tiered and cantilevered grandstands that have the effect of reducing the natural light, sunlight and air movement, thus placing enormous stress on the turf which can cause the formation of bare patches.

In our earlier patents we have disclosed techniques for providing large slabs of natural turf, These slabs are grown offsite and incorporate a random dispersion of plastics mesh sold under the registered trade mark REFLEX®. These slabs are large in cross section, usually 2.4 meters wide with preferred lengths being 2.4 m, 4.8 m, or 7.2 meters. The slabs usually have a depth of between 100 and 150 mm.

Specialized lifting equipment has been proposed to transport these slabs so that they can be laid in a lattice work to form an almost immediately usable playing surface. As the slabs wear they can be interchanged with slabs that are less prone to wear, or alternatively those that have been damaged the most such as in the goal mouths or center squares of football arenas can be replaced. The main advantage of these slabs is that they are grown offsite in the most optimum conditions where they get preferred light watering facilities and air movement. To prepare slabs of this kind there is a need for the slabs to remain in integrated form with a quality integrated root structure having the desired penetration. There is also a necessity for the slabs to be picked up and moved using conventional equipment. In situations where a slab of turf has suffered serious damage and the root structure has effectively died, it is important to be able to pick up the slab for removal and replacement without it falling apart. The root structure needs to be aerated and watered to optimum requirements and the structure of such Blabs must facilitate these parameters.

### SUMMARY OF THE INVENTION

It is these parameters and the problems in satisfying these needs that have brought about the present invention.

According to one aspect of the present invention there is provide a composite membrane comprising a first layer of fine mesh secured at closely spaced intervals to a plastics sheet, the plastics sheet having an array of apertures, the area of the apertures being less than 15%, preferably less than 10%, of the area of the sheet.

In accordance with a further aspect of the present invention there is provided a turf product comprising a sand/soil aggregate containing homogenous randomly positioned plastics reinforcements, grass growing in the aggregate with its root structure extending through the aggregate, the underside of the aggregate being positioned on a composite membrane comprising a first layer of fine mesh secured at closely spaced intervals to a plastics sheet, the plastics sheet having an array of apertures, the area of the apertures being less that 15%, preferably less than 10%, of the area of the sheet whereby the root structure integrates itself through the mesh and extends through the apertures in the sheet in discreet clumps whereby the product can be lifted by pulling the product including the membrane clear of the associated support structure.

### DESCRIPTION OF THE DRAWINGS

Embodiments of the invention will now be described by way of example only with reference to the accompanying drawings in which:

FIG. 1 is a perspective view of the top of a composite membrane for use with a turf product,

FIG. 2 is a perspective view of the composite membrane viewed from the underside,

FIG. 3 is a cross sectional view of a piece of turf with the membrane on the underside of the turf, and

FIG. 4 is a side elevation view of a roll of turf using the composite membrane.

### DESCRIPTION OF THE PREFERRED EMBODIMENT

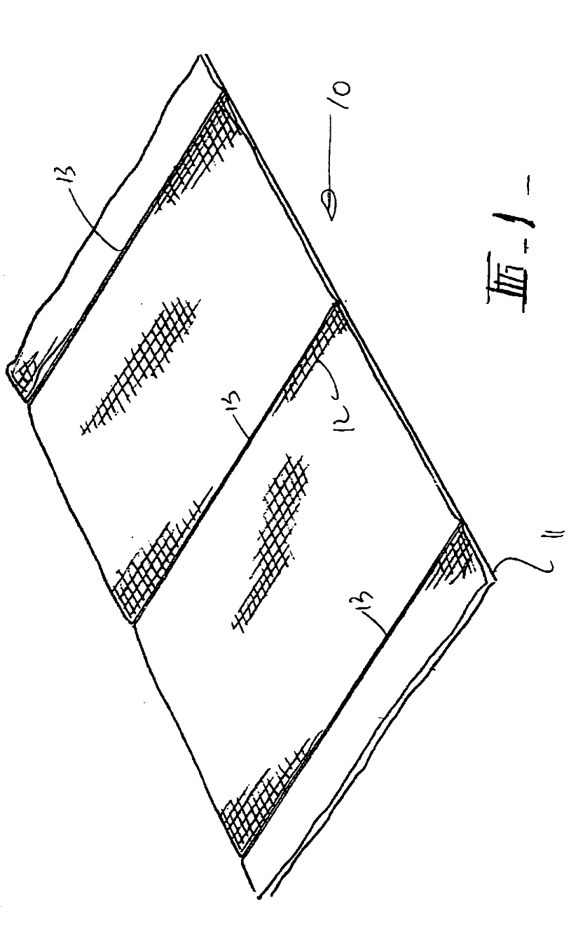

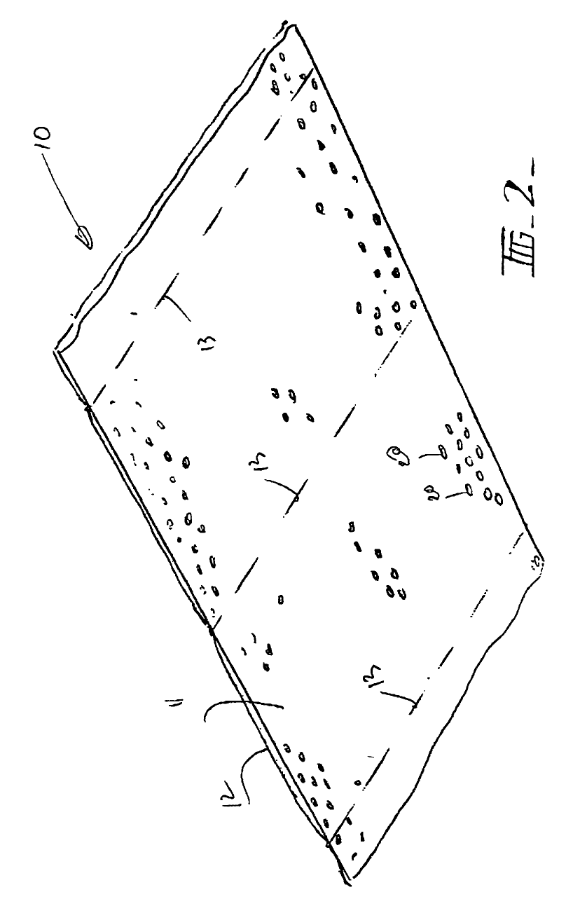

The composite membrane 10 shown in FIGS. 1 and 2, essentially comprises a sheet of high density polyethylene 11 that supports a mesh 12 of UV stabilised polypropylene having an aperture size of 3.5 mm square or 4.5 mm square.

This mesh is welded to the plastics sheet along longitudinal welds 13 that are spaced at 300 mm. The plastics sheet 11 is perforated with holes 20 with 41 mm spaced centers and 13 mm diameters so that the ratio of the area of the holes to the area of the sheet is 8%. The percentage area of the holes can vary to limit requirements. It is however envisaged that the area of the holes would be less than 15% of the area of the sheet. The thickness of the sheet 11 is preferably 1.5 mm though it is understood that certain embodiments a thinner sheet would be utilized. It is envisaged that the thickness of the plastics sheet 11 can vary from about 0.2 mm to 2 mm. Although in a preferred embodiment high density polyethylene is the preferred plastics it is understood that high density polypropylene could also be used.

The composite membrane 10 is provided in long rolls (130 meter) of 2.0 m wide product which can be cut to size to suit particular requirements.

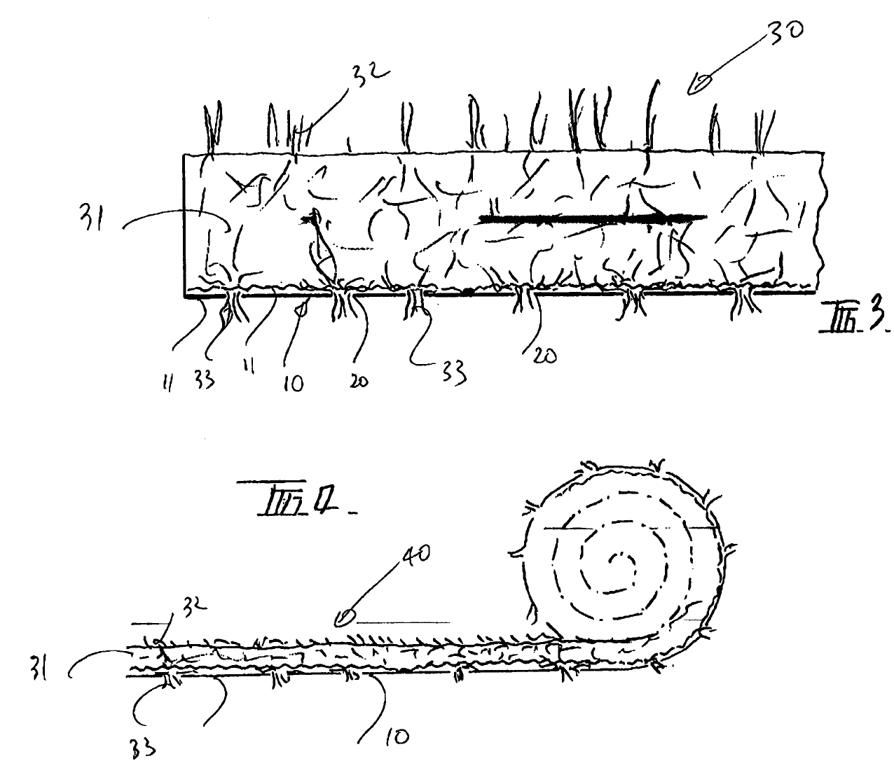

To produce slabs 30 of turf of the kind shown in FIG. 3 an aggregate mixture 31 of sand/soil and REFLEX® plastics mesh is placed over the membrane. The grass 32 grows in the aggregate until the roots 33 penetrate the mesh 11 to knot against the mesh. Smaller clumps of roots 33 then extend through the apertures 20 in the lower plastics sheet 11.

By securing the mesh 12 at closely spaced intervals to the polypropylene sheet 11, the root structure 33 easily penetrates the mesh 12 to become integrated with the mesh 12 and firmly secure the composite membrane 10 to the underside of the slab 30 of turf. The sparsity of apertures 20 in the plastics sheet 11 allows adequate drainage whilst allowing good root growth and depth whilst reducing the opportunity for the root structure to penetrate past the plastics sheet 11 into the substructure.

The roots can only go into the subsoil in small clumps which then makes it easy to shear off the slab at the sheet from the subsoil. The slab can either be simply pulled clear or a knife can be used to cut the clumps of roots 33 that do extend through the plastics sheet 11.

There are a number of advantages that flow from the use of a membrane 10 of this kind. In the first place the upper mesh layer 12 ensures that the membrane 10 becomes firmly and positively secured to the roots 33 of the grass 32 so that the slab 30 can be lifted with the membrane 10 in place. The lower plastics sheet 11 improves the aeration and drainage of the assembly but ensures that the root structure 33 does not positively secure the slab 30 to the substructure.

Once the turf has matured it can be removed by inserting gripping means into the turf and lifting the slab 30 with the membrane 10 clear of the substructure. If necessary, a knife can be used to cut the small clumps of roots 33 that may extend through the apertures 20 in the plastics sheet 11. However, the low proportion of apertures 20 in the plastics sheet 11 ensures a good shear surface to facilitate removal.

The slab 30 together with the membrane 10 can then be placed on site. In the event that the turf degenerates to the stage where the root structure dies off, replacement of the slab 30 can be ensured by placing suitable gripping means through the slab and the membrane 10 so that the slab is gripped from the underside. In an integrated healthy slab it can be lifted by simply gripping the turf. The composite membrane 10 thus ensures that each slab 30 is an integrated unit that can be removed and replaced on demand without fear of disintegration or the need for complicated cutting equipment to cut the root structure 33 to facilitate lifting. The composite membrane 10 also encourages root growth by improving the aeration and drainage at the base of the slab 30.

In a second embodiment shown in FIG. 4 the composite membrane 10 using a thinner plastics sheet 11 can also be used with thinner forms of turf 40 (30-50 mm) that can be rolled into a cylinder. The sheet 10 would be selected to provide the inherent flexibility to facilitate the rolling of the turf into a cylinder.

In one example is a 2.4 m wide roll of turf having a depth of 40-50 mm. The rolls are usually 8, 10, or 12 meters in length and can be used immediately for sports such as soccer and football.

The more flexible composite membrane 10 using thinner plastics sheeting 11 can be used an a substrate on which turf 32 can be grown and then, when it is ready for use, the turf and the membrane 10 can be simply rolled up into a cylindrical roll for transportation. The turf is then rolled out onto a suitably prepared surface to be ready for immediate use. In situations where the turf only has a temporary use it can then be rolled up again and returned to the growing venue for rejuvenation until it is needed again. In this way, turf can be reusable and can be hired instead of purchased.

Having now discussed my invention, what I claim is:

1. A composite membrane comprising a first layer of fine mesh secured at closely spaced intervals to a plastics sheet, the plastics sheet having an array of apertures, the area of the apertures being less than 15% of the area of the sheet.

2. The composite membrane according to claim 1 wherein the first layer of fine mesh is polypropylene with a mesh size of between 3.5 and 4.5 mm squares.

3. The composite membrane according to either claim 1 wherein the layer of mesh is welded to the plastics sheet along elongate welds spaced at between 250 and 350 mm.

4. The composite membrane according to claim 1 wherein the apertures in the plastics sheet constitute approximately 8% of the area of the sheet.

5. The composite membrane according to claim 1 wherein the apertures are approximately 13 mm in diameter.

6. The composite membrane according to claim 1 wherein the plastics sheet is high density polypropylene varying between 0.2 to 2 mm in thickness.

7. The composite membrane according to claim 1 wherein the composite membrane is produced in long rolls in a preferred width of 2.4 m.

8. A turf product comprising a sand/soil aggregate containing homogenous randomly positioned plastics reinforcements, grass growing in the aggregate with its root structure extending through the aggregate, the underside of the aggregate being positioned on a composite membrane comprising a first layer of fine mesh secured at closely spaced intervals to a plastics sheet, the plastics sheet having an array or apertures, the area of the apertures being less than 15% of the area of the sheet whereby the root structure integrates itself through the mesh and extends through the apertures in the sheet in discrete clumps whereby the product can be lifted by pulling the product including the membrane clear of an associated support structure.

9. A turf product according to claim 8 wherein the product is between 30 and 50 mm in depth, about 2.4 meters wide and lengths of about 8, 10, or 12 meters and can be rolled into a cylinder.

10. A turf product according to claim 8 wherein the product is between 100 and 150 mm in depth, about 2.4 meters wide and about 2.4, 4.8, or 7.2 meters long.
